(19) United States
(12) Patent Application Publication
(10) Pub. No.: US 2002/0174780 A1
(43) Pub. Date: Nov. 28, 2002

(54) Pressing of oil from plant material with the assistance of a gas under pressure

(76) Inventor: Anthony Alan Clifford, Leeds (GB)

Correspondence Address: JENKINS & WILSON, PA, 3100 TOWER BLVD, SUITE 1400, DURHAM, NC, 27707, US

(21) Appl. No.: 09/862,874

(22) Filed: May 22, 2001

(51) Int. Cl. B30B 9/02; B30B 15/20

(52) U.S. Cl. 100/37; 100/74

(57) ABSTRACT

A compressed gas, e.g. carbon dioxide, is injected under pressure into a press to increase the yield of oil from a natural material. The effect is brought about by the gas dissolving in the oil. The mass of gas required is typically less, often much less, than the mass of natural product.

The present invention involves a process for the extraction of oils from natural materials, by pressing, aided by the application of a gas under pressure to the natural material. The gas dissolves in the oil contained in it and improves the yield of oil that can be obtained by pressing it.

The mechanical pressing of natural substances, such as canola seeds or lemon peel, carried out to obtain the oil they contain, is a traditional process, carried on for nearly a century. According to L. F. Langhurst in Soybeans and Soybean Products, edited by K. S. Hartley, published by Interscience Publishers in New York in 1951, volume 1 page 524, linseed oil was first extracted by a screw press in 1906 and the technology has not changed greatly since that time.

Mechanical pressing does not, however, remove all the oil from the seed or plant material. For example, the oil content of linseed is reduced from about 40% to about 10% by mass by pressing. Thus a fraction of the oil remains in the seed and the residual oil, if required, must be removed by solvent extraction, for example by extraction with hexane. For some seeds, such as those of calendula, the oil content is so low that little or no oil can be obtained by pressing and all the oil must be obtained by solvent extraction.

A number of research studies have been carried out to increase the proportion of oil obtainable by pressing. For example, K. Sosulski and F. W. Sosulski report in Engineering and Food, edited by W. E. L. Spiess and H. Schubert, published by Elsevier Applied Science in London 1990, volume 3 page 656, that the recovery of oil from canola seed was increased from 79% to around 90% if the seeds were pre-treated with enzymes.

To avoid the use of organic solvents for plant extraction, which gives rise to environmental problems and undesirable residues in the products, gases under pressure, such as carbon dioxide, have been proposed as solvents for extracting oils from seeds and other materials and many studies have been made. The research on oil seeds has been reviewed by R. Eggers in Chapter 3 of Supercritical Fluid Technology in Oil and Lipid Chemistry, edited by J. W. King and G. R. List, published by the American Oil Chemists'Society Press in Champaign Illinois in 1996. In these processes, the oil is removed from the plant material by dissolving it in the gas at high pressures, typically between 300 bar and 900 bar. The solution that is removed is a solvent-rich phase, which in some cases can be described as a supercritical fluid phase and in others as a liquid phase.

In some proposed processes supercritical fluids otherwise described as gases under pressure have been combined with screw pressing. For example, Nikolaus Foidl in European Patent EP 0 822 893 B1 and in other related patents has proposed a system where a liquid or supercritical fluid is injected into a screw press and the liquid or supercritical fluid is used to extract an oil from a natural product. In another example, Rudolph Eggers and Ernst Gunter Schade in U.S. Pat. No. 4,675,133 have proposed that oil seeds and fruits are passed through a screw press and into a vessel through which a gas under pressure passes countercurrently to extract the oil. In both these cases the intention to dissolve the oil in order to extract it is implicit.

However, we have surprisingly found that gases, such as carbon dioxide, under pressure of up to 700 bar, but more typically up to 200 bar, can be used to assist the removal of oil from plant material without dissolving it in the carbon dioxide. We have found, conversely, that the carbon dioxide can be made to dissolve in the oil, increasing its volume and causing it to froth when pressure falls, consequently allowing it to be pressed from the plant material in greater yield than is obtainable by pressing in the absence of carbon dioxide. In the process which is the subject of this invention, the oil is removed as an oil-rich liquid phase composed as a mixture of the oil and the substance of the gas. This is in contrast to the processes, described earlier, in which the oil is removed in a solvent-rich phase.

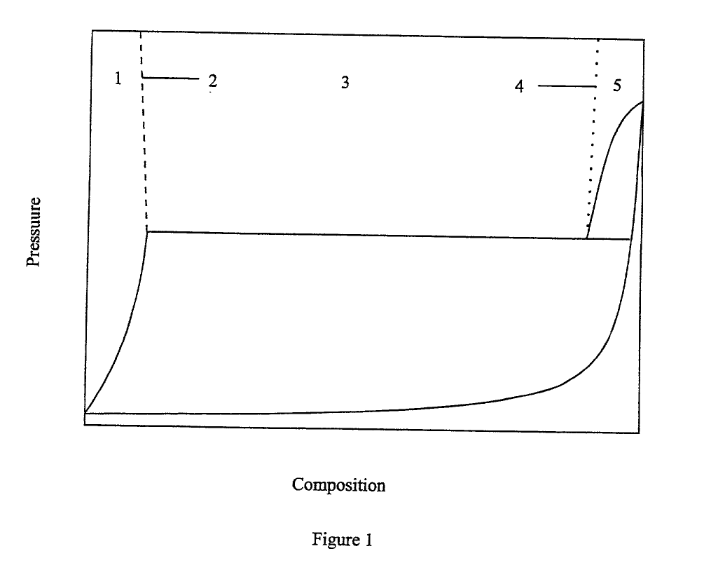

To explain further the difference between the present invention and the processes previously described, it is instructive to refer to phase diagrams of the binary mixture of an oil, treated as one component, and the substance of the gas under pressure. The gas may also be a mixture of substances and, although a gas under atmospheric pressure, it may be a liquid under the higher pressures used in the process or it may be described as a supercritical fluid at the higher pressures. Schematic phase diagrams are shown in FIGS. 1, 2 and 3, which are graphs of pressure versus composition at constant temperature. The left-hand side of these diagrams represents pure oil and the right hand side the substance of the gas applied under pressure, with the composition changing smoothly from pure oil to pure gas substance as the position moves to the right along the composition axis. The areas (1) at the left-hand side of FIGS. 1, 2 and 3, represent an oil-rich phase in which the gas may be considered to be dissolved in the oil. The oil-rich phase has a maximum composition of the substance of the gas, which is represented by the phase boundaries shown as dashed lines (2) on FIGS. 1, 2 and 3. The areas (5) at the left-hand side of FIGS. 1, 2 and 3, represent a phase which is rich in the substance of the gas, in which the oil may be considered to be dissolved in the substance of the gas, and which will be referred to as the solvent-rich phase. The solvent-rich phase has a maximum composition of the oil, which is represented by the phase boundaries shown as dotted lines (4) on FIGS. 1, 2 and 3. The areas (3) on FIGS. 1, 2 and 3 represent compositions in which both an oil-rich phase and a solvent-rich phase are formed.

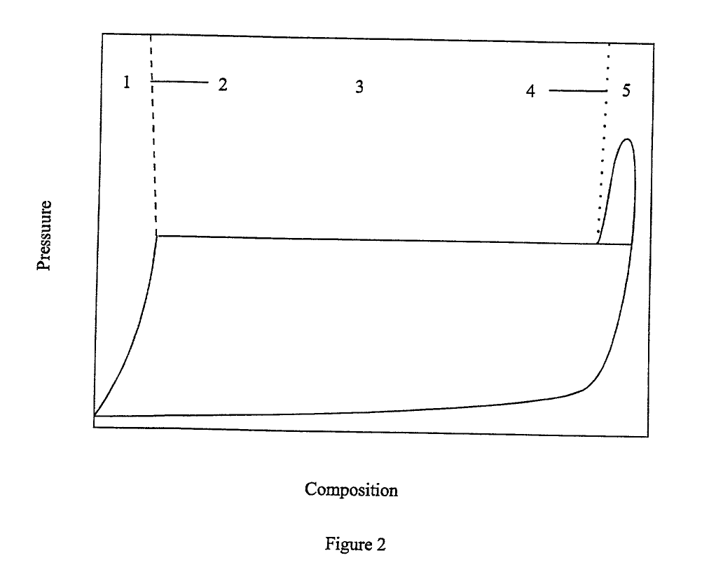

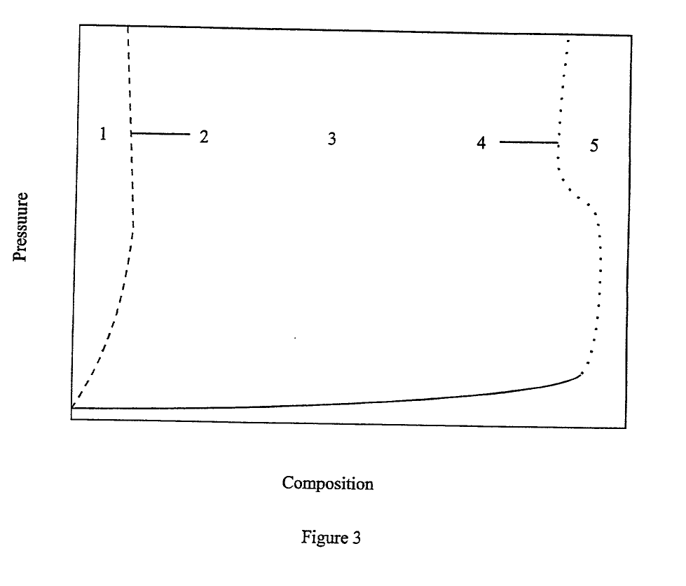

FIGS. 1, 2 and 3 represent different temperatures with respect to the critical temperature of the substance of the gas. In FIG. 1 the temperature is below the critical temperature of the substance of the gas; In FIG. 2 the temperature is a little above the critical temperature of the substance of the gas; and in FIG. 3 the temperature is well above the critical temperature of the substance of the gas. In FIG. 1, the area (5) is described as a liquid phase. In FIGS. 2 and 3, the area (5) is usually described as a supercritical fluid phase.

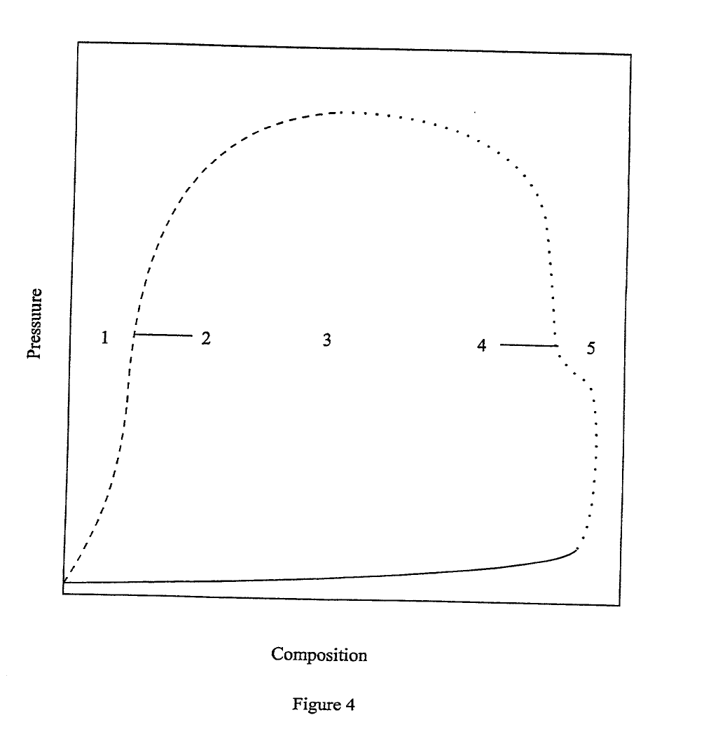

In some cases the phase boundaries (2) and (4) meet at higher pressures. FIG. 4 is a variant of FIG. 3 in which this occurs. Similar variants can be drawn for FIGS. 1 and 2. The pressure for the practice of this invention are chosen to be below that in which the phase boundaries (2) and (4) meet for a particular application.

In this invention, the oil is removed as an oil rich phase (1) rather than the solvent-rich phase (5) used in previously described processes.

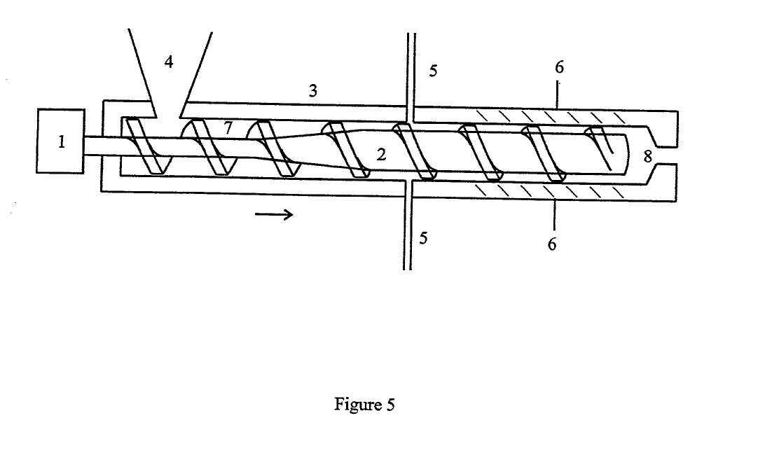

One possible system for carrying out this process, provided by way of example only, is shown in FIG. 5, which is a schematic drawing of a screw press, modified to allow the introduction of a gas under pressure. In FIG. 5 is a screw 2 which is rotated by a drive motor 1. The screw 2 is located within a barrel 3, which is fitted with a hopper 4 and entry points 5 for a pressurised gas. The hatched portion 6 of the barrel 3 contains perforations of some type, such as number of longitudinal slots. During the process, plant material is fed via the hopper 4 and into the cavity 7 between the screw 2 and the barrel 3 and the rotation of the screw forces it in the direction of the arrow shown towards the perforated end of the barrel 6. At the same time, due partly to the change in the size of the cavity 7, a pressure is developed in the plant material, which can be up to 300 bar and above. A gas, such as carbon dioxide, is then applied under pressure at points 5 along the barrel through a number of tubes. Conditions are chosen such that the pressure in the gas applied is slightly above the pressure developed in the screw press and the gas dissolves in the plant material or specifically in the oil contained within the plant material. When the plant material reaches the perforated section of the barrel 6, the oil, containing the dissolved gas is expressed from the barrel. The residual plant material passes to the end of the barrel and is extruded from the hole 8. The gas dissolved in the expressed oil comes out of solution in a container, not shown, and can be recycled, if required. The barrel can be cooled, if required, to remove the heat generated by the pressing process, by the circulation of cooling water, for example.

Other methods of introducing the gas are possible. It may be introduced as a latent gas, by which is meant a liquid or solid which forms a gas. Thus, in one example of the invention, carbon dioxide is introduced as solid carbon dioxide with the feed. This method has the advantage of also providing some of the cooling of the process required. Alternatively a liquid or supercritical fluid may be introduced, in each case capable of forming a gas under ambient temperature and pressure conditions.

A feature of the process, which further illustrates the difference that it has from existing processes, is that the ratio of the mass of the compressed gas required to that of the natural material is much lower. For the existing processes in which the oil is extracted by dissolving it in the compressed gas the mass of compressed gas required is more than that of the natural material. For example, U.S. Pat. No. 4,675,133, previously referred to, teaches that between 5 and 30 kg solvent is required per 1 kg pressed cake. By contrast, for this process, the mass of compressed gas required is typically less than 5 times the mass of the natural material, suitably less than 2 times, and may be lower than that of the natural material. In preferred methods the mass of compressed (or solidified) gas is not more than 50% of the mass of the natural material, and most preferably not more than 20%.

The solution of a gas into the oil during this process has an additional advantage. This is that the viscosity of the oil-gas mixture is much less than that of the oil alone, which means that less energy is required in the pressing process.

An example will now be described to illustrate the invention. Linseed containing 41.6% oil by weight was pressed at a rate of 50 kg per hour in a conventional manner, without gas assistance, in a small screw press modified as shown in FIG. 5, and the oil was collected. The residual oil content of the seeds after pressing was found to be 10.50% by weight. The same process was repeated on seeds from the same batch, with the additional application of carbon dioxide under pressure at a rate of 3 kg per hour and the residual oil content of the seeds, after pressing, was found to be 8.47% by weight. Taking into account the loss of moisture during the experiment without carbon dioxide 84.0% of the available oil was recovered. But with the additional application of carbon dioxide 87.6% of the available oil was recovered.

1. A method of extracting oil from a natural material, the method comprising the steps of
(i) providing a screw press having a screw, a motor to rotate the screw, a barrel within which the screw rotates, and having first and second ends, a feed port at the first end of the barrel for feeding into the barrel material to be pressed, an exit port at the second end of the barrel for pressed material to exit the barrel, and perforations in the barrel therebetween for expressing oil;
(ii) feeding into the barrel the natural material to be pressed while the screw rotates;
(iii) simultaneously with or subsequently to step (ii), feeding a gas or latent gas into the barrel thereby to dissolve in oil in the natural material; and
(iv) recovering oil which is expressed through the perforations.

2. A method as claimed in claim 1, wherein compressed gas is fed into the barrel.

3. A method as claimed in claim 2, wherein the barrel is provided with at least one feed port for compressed gas, at a position intermediate the first and second ends.

4. A method as claimed in clam 1, wherein frozen gas is introduced into the barrel with the natural material.

5. A method of increasing the yield of oil from a natural material by introducing a gas into a press so that it dissolves in the oil and assists the removal of the oil.

6. The method of claim 5 in which the mass of compressed gas used is less than five times the mass of natural material.
